(19) United States
(12) Patent Application Publication
(10) Pub. No.: US 2024/0199933 A1
(43) Pub. Date: Jun. 20, 2024

(54) A FIBRE BINDER COMPOSITION FOR RETAINING FIBRES AND OTHER PARTICLES ON A BUILDING SITE

(71) Applicant: FIBERBINDER APS, Albertslund (DK)

(72) Inventor: Jesper Haunstoft, Albertslund (DK)

(21) Appl. No.: 18/555,272

(22) PCT Filed: Apr. 15, 2022
(86) PCT No.: PCT/EP22/58955

§ 371 Date: Oct. 13, 2023

(30) Foreign Application Priority Data
Apr. 13, 2021 (EP) 21168067.3

(51) Int. Cl. C09K 3/22; C08L 71/02; C09D 5/22; C09D 7/41; C09D 7/63; E04G 23/08

(52) U.S. Cl. CPC C09K 3/22; C08L 71/02; C09D 5/22; C09D 7/41; C09D 7/63; E04G 23/08

(57) ABSTRACT

A composition is for retaining fibres and other particles on a building site to reduce the amount of airborne particles, such as asbestos or mineral wool fibres generated during demolition of a building structure. The composition includes a portion of sticky and mixable, non-toxic substance in the range of 70-90 wt-%, a portion of surfactant for facilitating easy mixing with water, preferably in the range of 1-10 wt-%, a traceable dye element substance, preferably in the portion of 0.01-5 wt-%, and the composition further includes a portion of a stickiness enhancing substance, preferably in the range of 5-15 wt-%.

### CROSS-REFERENCE TO RELATED APPLICATIONS

This application is the U.S. National Stage of PCT/EP2022/058955 filed on Apr. 5, 2022, which claims priority to European Patent Application 21168067.3 filed on Apr. 13, 2021, the entire content of both are incorporated herein by reference in their entirety.

### FIELD OF THE INVENTION

The present invention relates to a fibre binder composition for retaining fibres and other particles on a building site to reduce the amount of airborne particles, such as asbestos or mineral wool fibres generated during demolition of a building structure.

### BACKGROUND OF THE INVENTION

In connection with renovations of buildings, dismantling of fibrous building materials is often carried out. This involves releasing the fibres and other particles into the air. Such airborne particles cause a health risk to the construction workers on the building site both while dismantling the building structure as well as afterwards where construction workers move in to build a new building structure.

The old building materials that may be subject to dismantling may include asbestos fibres, mineral wool fibres and the like that constitute serious health risks for people on the site.

In order to reduce the amount of airborne dust and fibres, it is known to apply composition which is sprayed onto the building structure to bind fibres and dust to the surface of the building structure and thereby reduce the asbestos fibre materials from being released into the air. Examples of such compositions used for wetting and encapsulating fibres are known from U.S. Pat. Nos. 4,828,883, 4,866,105 and 5,108,788.

These known compositions are diluted in water and sprayed onto the surface of the building structure. From U.S. Pat. No. 4,828,883 it is furthermore known to use a dye to indicate the saturation and the depth of penetration of the wetting material.

A disadvantage with these known wetting materials is that the wetting liquid may lose its stickiness over time and the liquid may evaporate over time. Thus, it is an object by the present invention to improve the duration of the wetting composition and its stickiness. It is a further object to provide a composition which can easily be identified to what extent it is present on the building structure.

### SUMMARY OF THE INVENTION

These objects are achieved in a first aspect of the invention by providing a fibre binder composition for retaining fibres and other particles on a building site to reduce the amount of airborne particles, such as asbestos or mineral wool fibres generated during demolition of a building structure, said composition comprising:
a portion of sticky and mixable, non-toxic substance in the range of 70-90 wt-%,
a portion of surfactant for facilitating easy mixing with water, said portion preferably being in the range of 1-10 wt-%,
a traceable dye element substance, preferably in the range of 0.01-5 wt-%, and wherein the composition further comprises a portion of a stickiness enhancing substance, preferably in the range of 5-15 wt-%, and wherein the stickiness enhancing substance is selected from a group consisting of: Acetic acid ethenyl ester, polymer with 1-ethenyl-2-pyrrolidinone), PVP (polyvinyl pyrrolidone), PVP-VA (polyvinyl pyrrolidone-vinyl acetate), VP (vinyl pyrrolidone)/methylacrylamide/vinyl imidazole copolymers,

Acrylates type copolymers, Butyl or ethyl esters of PVM/MA (polyvinyl methyl ether and maleic anhydride) copolymers, Guarhydroxypropyltrimonium chloride,

Hydroxyethyl methylcellulose, Hydroxypropyl methylcellulose, Polyquaterium-69, polyquaterium-4, polyquaterium-46, polyquaterium-28, and/or polyquaterium-39.

Hereby, there is achieved a composition which can be applied by spraying the fibre binder composition onto the surfaces of a relevant building structure by a handheld spraying device. The liquid composition is sticky and thereby retains lose fibres and other dust particles. The composition when applied is diffusion open so that moisture in the building structure can escape. This prevents damages to the building structure due to moisture in the building structure.

The composition according to the invention is further advantageous because the composition has a good duration and stickiness and that it can be traced. This means that the composition is suitable for use not only immediately prior to a demolition operation but also can be sprayed onto the remaining building structure so that the building site is made secure for workers to work on for a longer period of time.

The composition is furthermore advantageous as it is traceable so that it can be checked if the fibre binding composition is present and if the time limit for the composition product has expired.

By the invention, it is found advantageous that the sticky and mixable, non-toxic substance is any of polyethylene glycol (PEG), mono-ethylene glycol (MEG), propylene glycol and/or a mixture thereof.

It is realised that the sticky and mixable, non-toxic substance, such as polyethylene glycol (PEG), mono-ethylene glycol (MEG), propylene glycol (or mono-propylene glycol (MPG)) and/or a mixture thereof has excellent fibre and particle binding properties. This large portion of sticky substance is then supplemented by a portion of a stickiness enhancing substance to design the fibre binder composition to a specific type of fibre and dust retention. Accordingly, the stickiness enhancing substance is selected from a group consisting of the listed copolymers. The stickiness enhancing substance may ensure the stickiness properties are maintained also after mixing.

In an embodiment it may be advantageous for some applications to be able to use the composition which has been applied to the surface on a building site and a primer for a subsequent coating of the relevant surfaces of the building site. Accordingly, the composition may be provided with a suitable copolymer for instance of the Acrylates type copolymers in combination with a moisture additive.

In one embodiment, the dye element substance is a colour additive. Natural colours that are non-toxic can be added to the composition so that the binder composition can easily be visually identified.

In an advantageous embodiment of the invention, the dye element substance is a fluorescent substance, which is traceable by visible light and/or ultraviolet light. Some currently preferred fluorescent substances are fluororescein or quinine. These may be used in addition to or as an alternative to colour additives.

As an alternative or in addition to the other types of traceable dye element, the dye element substance is a glittering material or any other kind of material responsive to light.

In a preferred embodiment, the dye element substance is traceable after application for at least 7 days up to three months, preferably approx. 14 days. The visibility then disappears together with the decline in the fibre binding properties of the fibre binder composition. The dye element substance is preferably also biodegradable.

In the preferred embodiments of the invention, the fibre binder composition is mixed with water in a ratio of 1:1-4 before use, preferably a ration of approx. 1:3 before use. Hereby, the fibre binder composition can be extended to a larger area of use. The surfactant such as soap is added to the composition in order to facilitate that the composition can be mixed with water. In order to support this effect, the surfactant in the composition may be sodium lauryl sulfate or other types of soaps.

In a second aspect there is provided a method of applying a fibre binder composition, whereby said composition is mixed with water and applied onto a surface of a building structure, characterised in that the step of applying the composition is performed by a low pressure spraying, e.g. using a high volume low pressure (HVLP) or a low volume low pressure (LVLP) spray gun or handheld sprayer, until the surface is soaked. Hereby, it is avoided that fibres and dust, such as asbestos particles, are spread during the application of the fibre binder composition.

In a third aspect, the invention also involves a use of a composition according to the first aspect for the performance of a method according to the second aspect, whereby the composition is applied to the surface of a building structure to achieve a sticky surface so that fibres and other particles are retaining on a building site to reduce the amount of airborne particles, such as asbestos or mineral wool fibres generated during a demolition or renovation of the building structure.

### DETAILED DESCRIPTION OF THE INVENTION

An example of a fibre binder composition for retaining fibres and other particles on a building site according to the present invention is listed in table 1 below:

TABLE 1
An example of a composition according to the invention.

| Substance | Content % w/w |
|---|---|
| Polyethylene glycol | 70-90% |
| Acetic acid ethenyl ester, polymer | 5-15% |
| with 1-ethenyl-2-pyrrolidinone | |
| Sodium lauryl sulphate 2-(6-Hydroxy- | 1-10% |
| 3-oxo-(3H)-xanthen-9-yl)benzoic | 0.01-5% |
| acid (fluororescein) | |

The composition is prepared for mixing with water in a ratio of 1:1 before application onto the surfaces of the building site.

This composition/mixture does not contain any components that are considered to be either persistent, bioaccumulative and toxic (PBT) or very persistent and very bioaccumulative (vPvB) at levels of 0.1% or higher.

The composition is applied by a low pressure spraying, e.g. using a high volume low pressure (HVLP) or a low volume low pressure (LVLP) spray gun or handheld sprayer, until the surface is soaked. Hereby, it is avoided that fibres and dust, such as asbestos particles, are spread during the application of the fibre binder composition unlike if a high-pressure sprayer is used.

High volume low pressure (HVLP) is similar to a conventional spray gun using a compressor to supply the air, but the spray gun itself requires a lower pressure (LP). A higher volume (HV) of air is used to aerosolize and propel the composition at lower air pressure.

### EXPERIMENT

The effect of the composition according to the invention was tested, and to that effect a composition as defined above in table 1 was mixed. The composition after mixing appeared as a red coloured liquid, which after drying leaves a sticky surface with a “greasy” feel that binds fibres. The composition was added a fluorescent substance so that any application of the composition to a surface can be detected by UV light by quality inspection.

The test set-up

A test box made of transparent acrylic plates with an inlet. A cardboard box is provided with a sticky tape cover and placed in the bottom of the test box. A soft plate of asbestos with Chrysotil and Amosit (70-75%) is disintegrated and spread over the sticky cardboard surface. The inlet, which is just above the cardboard surface in the transparent test box, is provided with a blower for blowing air around in the box to create a vortex inside the test box where a whirlwind is created. Besides the air blower for blowing air around in the box there is provided means for carrying out aerial fibre measurements in the test box.

The transparent acrylic glass panes are sealed and the air blower is used to stir up free asbestos fibres in the air which can then be measured by using a standard asbestos analysis (a modified method: DS2169/NIOSH 7400).

The test box was placed in an uninsulated shed under the roof and the temperature in part of the test period was up to around 40° C., which simulates conditions underneath a roof and a complete cover of a scaffold during the summer months in northern Europe.

The test is using a limited volume in the test box, a strong air turbulence and a very high concentration of asbestos material compared to covered roof surfaces that have been cleaned for asbestos. This results in measurements which may be regarded as representative of a “worse case” scenario.

### Results

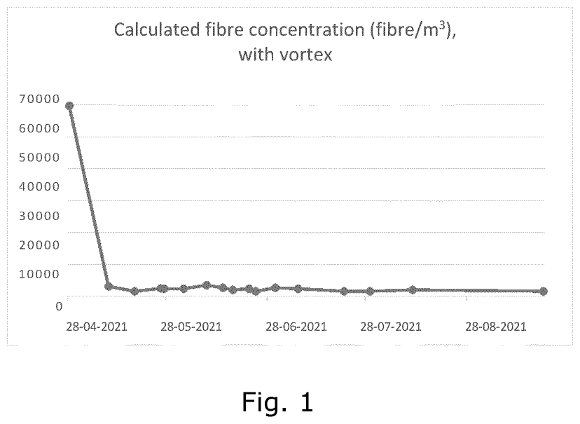

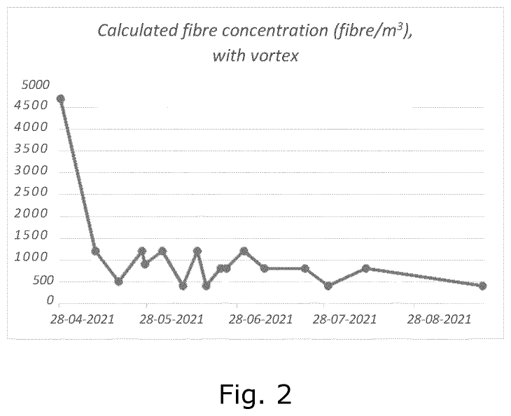

In FIGS. 1 and 2, the fibre concentration with and without the vortex created by the air blower is shown for a series of measurements over time, where the x-axis are the dates of the measurements and the y-axis is the fibre concentration in fibres/m3. In both figures, the first measurement of 28-04-2021 is before the application of fibre binder.

In table 2 below a small but representative extract of the results from the test is listed:

TABLE 2
Extract of measurements

| | Without fibre | With fibre |
|---|---|---|
| | binder | binder |
| | (fibre/m³) | (fibre/m³) |
| Initial measurement without vortex | 4,700 | — |
| (28 Apr. 2021) | | |
| Initial measurement with vortex | 59,700 | — |
| (28 Apr. 2021) | | |
| First series of measurements without vortex | — | 3,100 |
| (10 May 2021) | | |
| First series of measurements with vortex | — | 1,200 |
| (10 May 2021) | | |
| Second series of measurements with vortex | — | 1,600 |
| (18 May 2021) | | |
| Sixteenth series measurement with vortex | — | 1,600 |
| (20 Sep. 2021) | | |

By the first initial measurement, i.e. without the application of the fibre binder composition, a very high concentration of asbestos fibres in the air was registered, in particular after the vortex was created inside the test box.

By the subsequent measurements, i.e. with the fibre binder composition applied, a significant reduction of asbestos fibres in the air is registered compared to the initial measurement. The fibre concentration with the fibre binder composition applied are considerably below the initial fibre concentration measurement, and the measurements over time show that the effect of the fibre binder is maintained throughout the measurement period of the test with only minor fluctuations.

The tests shows that the fibre binder product can reduce the fibre concentration with up to 97% with the air exposure of the surface.

It is also observed that the surface continued to be sticky throughout the test period, which indicates that the fibre binder product does not dry out completely and that there is only a minimal risk that once attached fibres are released. Thus, it is found that the fibre binder product has a lasting effect which is maintained for the whole of the test period of three months.

Above the present invention has been described in connection with the specified embodiments. However, it should not be construed as being in any way limited to the presented examples. The scope of the present invention is set out by the accompanying claims. In the context of the claims, the terms “comprising” or “comprises” do not exclude other possible elements or steps. Also, the mentioning of references such as “a” or “an” etc. should not be construed as excluding a plurality.

1.-15. (canceled)

16. A fibre binder composition for retaining fibres and other particles on a building site to reduce the amount of airborne particles, such as asbestos or mineral wool fibres generated during demolition of a building structure, said composition comprising:
a portion of sticky and mixable, non-toxic substance in the range of 70-90 wt-%;
a portion of surfactant for facilitating easy mixing with water being in the range of 1-10 wt-%;
a traceable dye element substance, in the portion of 0.01-5 wt-%; and
a portion of a stickiness enhancing substance in the range of 5-15 wt-%, the stickiness enhancing substance being selected from a group consisting of:
Acetic acid ethenyl ester, polymer with 1-ethenyl-2-pyrrolidinone),
PVP (polyvinyl pyrrolidone),
PVP-VA (polyvinyl pyrrolidone-vinyl acetate),
VP (vinyl pyrrolidone)/methylacrylamide/vinyl imidazole copolymers,
Acrylates type copolymers,
Butyl or ethyl esters of PVM/MA (polyvinyl methyl ether and maleic anhydride) copolymers,
Guarhydroxypropyltrimonium chloride,
Hydroxyethyl methylcellulose,
Hydroxypropyl methylcellulose, and
Polyquaterium-69, polyquaterium-4, polyquaterium-46, polyquaterium-28, and/or polyquaterium-39.

17. A fibre binder composition according to claim 16, wherein the sticky and mixable, non-toxic substance is any of polyethylene glycol (PEG), monoethylene glycol (MEG), propylene glycol (MPG) and/or a mixture thereof.

18. A fibre binder composition according to claim 16, wherein the dye element substance is a colour additive.

19. A fibre binder composition according to claim 16, wherein the dye element substance is a fluorescent substance, which is traceable by visible light and/or ultraviolet light.

20. A fibre binder composition according to claim 19, wherein the fluorescent substance is fluororescein or quinine.

21. A fibre binder composition according to claim 16, wherein the dye element substance is a glittering material or any other kind of material responsive to light.

22. A fibre binder composition according to claim 16, wherein after application the dye element substance is traceable for at least 7 days up to three months, preferably approx. 14 days.

23. A fibre binder composition according to claim 22, wherein after application the dye element substance is traceable for approx. 14 days.

24. A fibre binder composition according to claim 16, wherein the dye element substance is biodegradable.

25. A fibre binder composition according to claim 16, wherein the composition further comprises the portion of a stickiness enhancing substance in the range of 5-10 wt-%.

26. A fibre binder composition according to claim 16, wherein the composition is mixed with water in a ratio of 1:1 to 1:4 before use

27. A fibre binder composition according to claim 26, wherein the ratio is approx. 1:3 before use.

28. A fibre binder composition according to claim 16, wherein the surfactant is sodium lauryl sulfate or other types of soap.

29. A fibre binder composition according to claim 16, wherein the composition when applied is diffusion open.

30. A method of applying a fibre binder composition for retaining fibres and other particles on a building site to reduce the amount of airborne particles, such as asbestos or mineral wool fibres generated during demolition of a building structure, said composition comprising:
a portion of sticky and mixable, non-toxic substance in the range of 70-90 wt-%;
a portion of surfactant for facilitating easy mixing with water being in the range of 1-10 wt-%;
a traceable dye element substance, in the portion of 0.01-5 wt-%; and
a portion of a stickiness enhancing substance in the range of 5-15 wt-%, the stickiness enhancing substance being selected from a group consisting of:
Acetic acid ethenyl ester, polymer with 1-ethenyl-2-pyrrolidinone),
PVP (polyvinyl pyrrolidone),
PVP-VA (polyvinyl pyrrolidone-vinyl acetate),
VP (vinyl pyrrolidone)/methylacrylamide/vinyl imidazole copolymers,
Acrylates type copolymers,
Butyl or ethyl esters of PVM/MA (polyvinyl methyl ether and maleic anhydride) copolymers,
Guarhydroxypropyltrimonium chloride,
Hydroxyethyl methylcellulose,
Hydroxypropyl methylcellulose, and
Polyquaterium-69, polyquaterium-4, polyquaterium-46, polyquaterium-28, and/or polyquaterium-39,
whereby said composition is mixed with water and said mixture is then applied onto a surface of a building structure;
the step of applying the mixture being performed by a low pressure spraying until the surface is soaked.

31. A method according to claim 30, wherein the composition is mixed with water in a ratio of 1:1 to 1:4 before use.

32. A method according to claim 31, wherein the ratio is approx. 1:3 before use.
